(19) United States
(12) Patent Application Publication
(10) Pub. No.: US 2011/0186309 A1
(43) Pub. Date: Aug. 4, 2011

(54) Animal Shoe and Methods for Securing with Animal Foot

(76) Inventor: Steven Hoselton, Lexington, IL (US)

(21) Appl. No.: 13/012,933

(22) Filed: Jan. 25, 2011

Related U.S. Application Data
(60) Provisional application No. 61/301,178, filed on Feb. 3, 2010.

(51) Int. Cl. A01L 3/00

(52) U.S. Cl. 168/17

(57) ABSTRACT

A horseshoe for securing to an animal foot and methods for forming and securing the horseshoe to an animal foot are disclosed. A body portion contains at least one channel having a cross-sectional shape that is wider at a level below a top surface than at an upper level. The channel retains a rigid material forming a bonding lug which is substantially co-planar with the top surface of the horseshoe body. The bonding lug interacts with a bonding agent to increase the strength of the bond between the horseshoe and the animal foot.

### CROSS-REFERENCE TO RELATED APPLICATION

This application claims the benefit of U.S. Provisional Patent Application No. 61/301,178, entitled “Animal Shoe and Methods for Securing with Animal Foot,” filed Feb. 3, 2010.

### FIELD OF THE INVENTION

The invention relates to devices securable with an animal foot, such as a horseshoe secured to a horse's hoof, to methods for constructing such devices, and to methods for securing such devices, and in particular, to an animal shoe having an undercut groove or channel for forming a lug that is bonded with the animal foot.

### BACKGROUND

Animal shoes such as horseshoes and the like are well known and likely familiar to any person. Generally speaking, the best known manner for securing a horseshoe to a horse's hoof is by driving nails through holes in the shoe and into the hoof The nails are relatively slender so as to minimize the possibility of causing a crack in the hoof and have a head to retain the shoe on the hoof The head typically sits in a countersunk region of the shoe to minimize abrasion when the horse moves, and such often requires use of a punch or awl used in combination with a hammer to set the nail.

In a typical application of a shoe, a farrier first prepares the hoof This is somewhat akin to a manicure in which the surface and edges are shaped and smoothed to remove burrs and the like. The farrier then selects a size and type of shoe based on the horse hoof and expected conditions for the horse. A skilled farrier is usually successful on an immediately proper selection of a shoe, though one may occasionally place the shoe against the hoof only to realize the shoe is not be a good match.

It is expected that a properly selected shoe will still require some adjustment. That is, the arc or curve of the shoe is often adjusted once the shoe is compared directly to the animal's hoof Aluminum is much easier than iron for the farrier to shape and re-shape on an anvil due to its relative softness.

Some attempts have been made to glue shoes on horses. For example, SoundHorse Technologies of Unionville, Pa., has produced several types of shoes that are securable to a hoof via glue, without the need for nails. However, such shoes are more of a system, being relatively complex and complicated to apply. The shoes include a base portion that would resemble what one would commonly expect to see as a shoe. The periphery of the base portion is connected with a partial or C-shaped cloth-like sleeve extending upward from the base portion, an opening in the sleeve defining the C-shape and being coincident with the open portion of the horseshoe-shaped base portion. In applying the shoe, the farrier must pay careful attention to having the outer edge of the base portion aligned with the edge of the hoof The sleeve is then glued to the outside of the hoof to retain the base portion against the bottom of the hoof The whole process requires a significant amount of time, shoe shaping, and careful positioning.

Accordingly, there has been a need for an improved animal shoe.

### BRIEF DESCRIPTION OF THE DRAWINGS

In the Figures, FIG. 1 is a perspective view of an animal shoe of the present invention in the form of a horseshoe;

FIG. 2 is a top plan view of the animal shoe of FIG. 1 showing bonding lugs deposited in channels formed in a body of the shoe;

FIG. 3 is a side elevational cross-sectional view taken through the line 3-3 of FIG. 2

showing a cross-sectional shape of the channels in the body and showing a cross-sectional shape of the bonding lug producing an interference fit between the lug and the channel;

FIGS. 4 and 5 are perspective views of the shoe without the bonding lugs in

the
channels; and

FIG. 6 is a side elevational view of the shoe of FIG. 1 with a cross-sectional graphical representation of an animal hoof secured with the bonding lugs via a bonding agent in a bonding region of the hoof.

### DETAILED DESCRIPTION

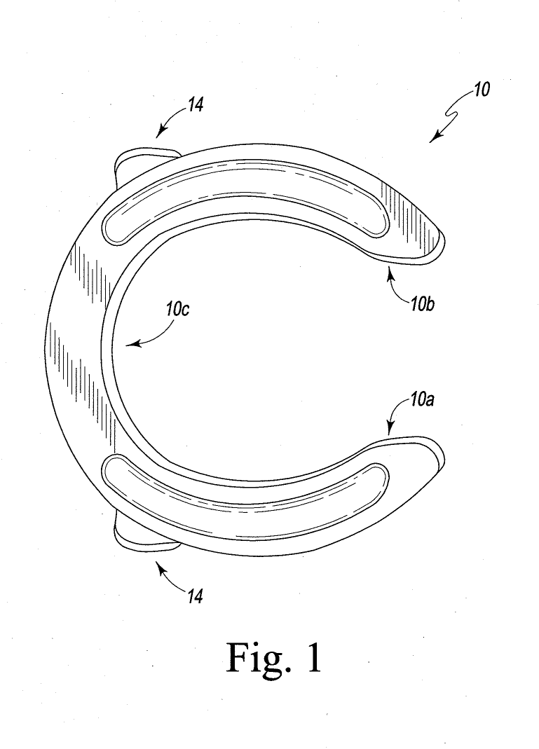

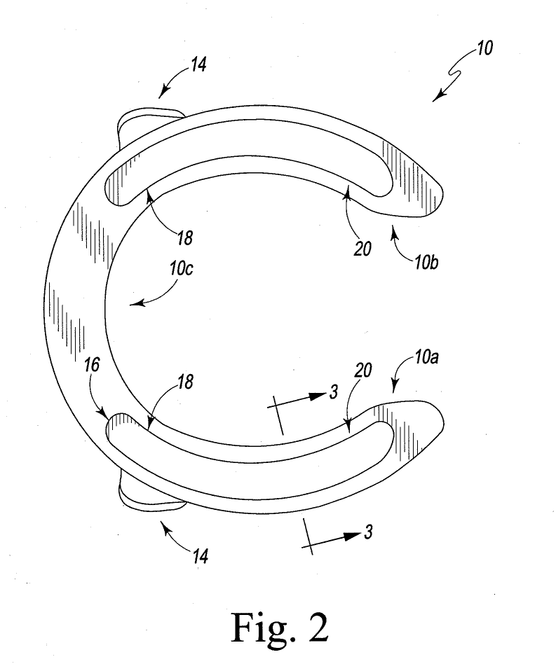

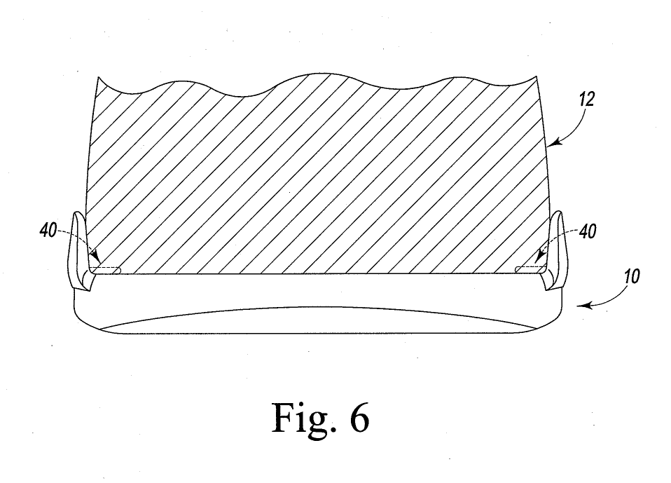

Referring initially to FIGS. 1 and 2, an embodiment of an animal shoe of the present invention in the form of a shoe 10 for a hoof 12 (FIG. 6) of an animal such as a horse (not shown) is illustrated. The shoe 10 is formed in a typical horseshoe-shape such that there are two legs 10a, 10b, and a central arc 10c connecting the legs 10a, 10b. Two clips 14 are illustrated though these may vary in number and size, as is well known in the art.

As a broad description of one aspect of the present invention, the shoe 10 is secured with the hoof 12 via a bonding agent 40 (FIG. 6, discussed in greater detail below) that bonds with the hoof 12 and bonds with a distinct portion of the shoe that forms an interference with the meta of the shoe 10. In the present embodiment, the shoe 10 includes a bonding lug portion 16 and, in the present form, each leg 10a, 10b includes a bonding lug 18 of the bonding lug portion. The bonding lugs 18 are formed of a material other than that of the shoe 10, the bonding lugs 18 being deposited in respective channels 20 (discussed in greater detail below) of the legs 10a, 10b. In particular, the bonding lugs 18 may be a glue, a curable epoxy, or another polymeric material. As such, the bonding lugs 18 form a relatively rigid structure within the channels 20.

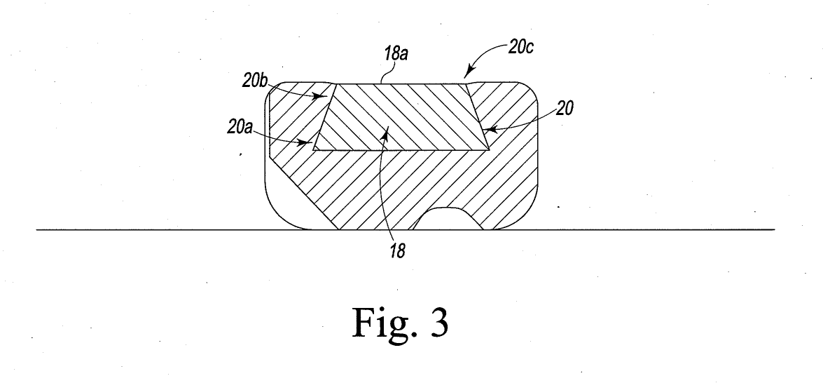

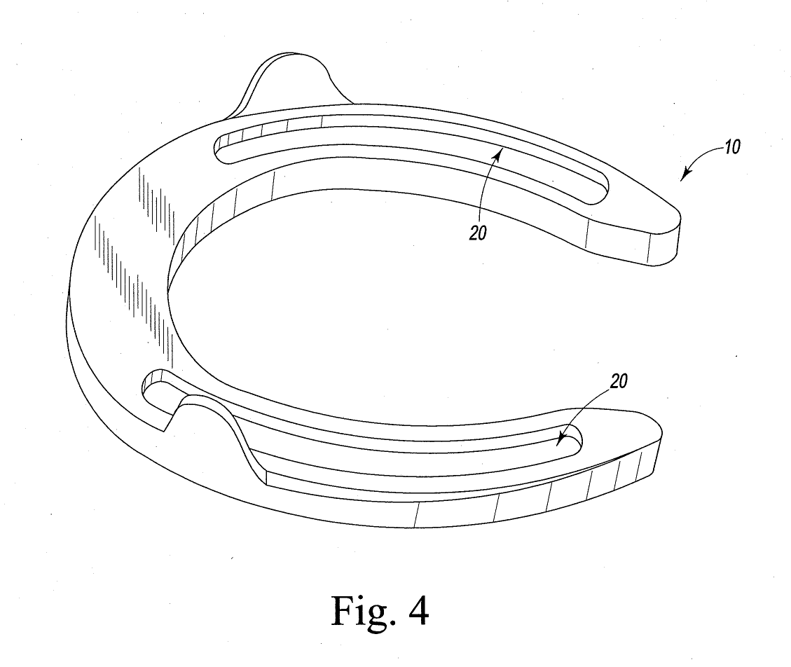

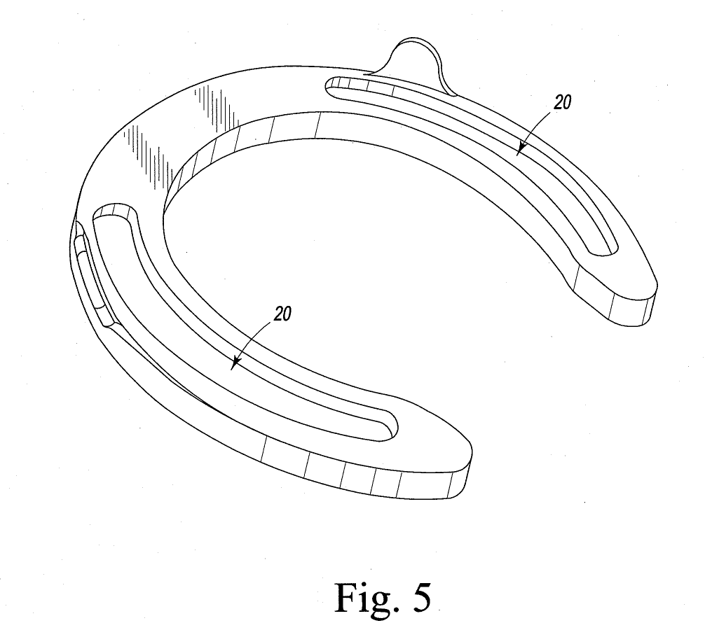

Turning to FIG. 3, the structural shape of the bonding lugs 18 and the channels 20 can be seen. Generally speaking, the channel 20 is undercut so that the cross-sectional shape thereof is wider at a level 20a below a top surface 22 than at an upper level 20b, for instance. More generally, the channel 20 is shaped so that the deposited bonding lug 18 forms an interference fit with respect to the opening 20c of the channel 20, thereby preventing the bonding lug 18 from being pulled out of the channel 20.

To form the shoe channel 20 of the present form, a frusto-conical bit (not shown) may be advanced into the shoe 10, initially forming a simple rectangular cross-section for the channel 20. The frusto-conical bit is then shifted laterally to either side of the center line of the channel 20 to form the undercut. It should be appreciate that other methods of forming the channel 20 with a shape that prevents separation or removal of the lug 18 from the channel 20 are within the scope of the present teaching. It should also be noted that the size and extent of the channels 20 form the current preferred embodiment as they provide a significant amount of bonding area comparable to a range over which nails would normally be utilized for securing a conventional shoe.

Material is then deposited in the channels 20 to form the bonding lugs 18. While the top surface level 18a of the bonding lug 18 need not be perfectly flat, it is advantageous in securing the shoe 10 to the hoof 12 for such to be close to coincident with the opening 20c of the channel 20. If the bonding lug 18 is shy of the opening 20c (i.e., below), additional bonding agent 30 (discussed below, see FIG. 6) may be necessary, or insufficient bonding agent 30 may accidentally be applied. If the bonding lug 18 extends beyond the opening 20c (i.e., out of the channel 20), the bonding lug 18 may cause an improper mating between the shoe 10 and the hoof 12.

To secure the shoe 10, the hoof 12 is first prepared. This preparation includes a good balanced trim of the hoof 12, and all flaky hoof material is ideally removed. The shoe 10, preferably formed of aluminum, is shaped for the individual hoof such as by a farrier on an anvil. If one or more clips 14 are present, they should be set to the hoof wall angle. The hoof 12 should be dry and, preferably, drying to continue for 45 seconds to a full minute.

The shoe 10 is also prepared. This involves brushing off the gloss from the hoof 10 or, generally, roughing the surface of the shoe 10 and the bonding lugs 18 to increase bonding properties as is commonly understood for all adhesive-type applications. Next, it is preferred that the shoe 10 be wiped with denatured alcohol, then permitted to dry.

Obviously, some of these steps could be performed in a different order. Spacers may also be used.

A bonding agent 40 is then applied, and the shoe 10 is applied to the hoof 12. In the preferred form, the bonding agent 40 chemically bonds with the bonding lugs 18, and the bonding agent 40 bonds with the hoof 12. In a preferred form, the bonding agent 40 flows into the somewhat porous material of the hoof 12 to form somewhat of a lattice therewithin. Depending on selection of a bonding agent 40, time should be given for the bonding agent 40 to set and bond with both the hoof 12 and the bonding lugs 18.

It should be noted that a basic concept of the invention is that the bonding agent 40 bonds directly with and into the hoof 12, and that the bonding agent 40 bonds directly with the bonding lugs 18. The connection between the bonding agent 40 and the bonding lugs 18 is preferably a bond other than simply a surface bond, such as would be the case with an epoxy-toaluminum surface interface. More broadly, it is noted that the bonding lugs 18 could be formed of a porous material such that the bonding agent 40 seeps into the bonding lugs 18 so that, upon hardening with the bonding lugs 18, the bonding agent 40 forms an interference fit or lattice within the bonding lugs 18. Accordingly, the bonding lugs 18 may also simply be a porous structure such as a sintered metal formed integral with the shoe 10 or deposited in the channels 20 in a separate step.

While the invention has been described with respect to specific examples including presently preferred modes of carrying out the invention, those skilled in the art will appreciate that there are numerous variations and permutations of the above described systems and techniques that fall within the spirit and scope of the invention.

what is claimed is:

1. A horseshoe, comprising
a body portion having a ground-facing surface and a hoof-facing surface;
at least one channel disposed on the hoof-facing surface, the channel having an opening with a first width, and a second width below the opening greater than the first width;
a bonding lug disposed within the channel.

2. The horseshoe of claim 1 wherein a cross-sectional shape of the channel is a dovetail.

3. The horseshoe of claim 1, wherein the body portion includes first and second legs respectively having first and second channels disposed therein.

4. The horseshoe of claim 1, wherein the bonding lug is retained within the channel by an interference fit.

5. The horseshoe of claim 1, wherein a top surface of the bonding lug is substantially co-planar with the hoof-facing surface.

6. The horseshoe of claim 1, further comprising a bonding agent disposed on the hoof-facing surface of the horseshoe.

7. The horseshoe of claim 6, wherein the bonding agent is disposed on and bonds with the bonding lug.

8. The horseshoe of claim 7, wherein the bonding agent chemically bonds with the bonding lug.

9. The horseshoe of claim 8, wherein the bonding agent chemically bonds with the bonding lug by forming an interference fit or a lattice structure.

10. The horseshoe of claim 1, wherein the bonding lug is composed of a glue, curable epoxy, or other polymeric material.

11. The horseshoe of claim 1, wherein the at bonding lug is integrally formed with the body portion of the horseshoe.

12. A method of forming a shoe for an animal foot, comprising the steps of
forming a channel within a body portion of the shoe having an opening at a hoof-facing surface of the shoe;
disposing a bonding lug within the channel;
disposing a bonding agent to the bonding lug.

13. The method of claim 11 wherein forming the channel includes the step of undercutting the channel, thereby forming a cross-sectional shape of the channel having a first width at the opening and a second width below the opening, the second width being greater than the first width;

14. The method of claim 11 wherein forming the channel includes the step of
using a bit to form a rectangular cross-section for the at least one channel, and
shifting the bit laterally to the sides of a longitudinal centerline of the channel.

15. The method of claim 11 further comprising the step of leveling a top surface of the bonding lug, wherein the hoof-facing surface and a top surface of the bonding lug are substantially coplanar.

16. A method for securing a shoe to an animal foot, comprising the steps of
forming a horseshoe having a channel in a body portion of the horseshoe, the channel having a first width at an opening and a second width at a point between a hoof-facing surface and a ground-facing surface, the second width being greater than the first width;
disposing a bonding agent on the hoof-facing surface of the shoe,
wherein the bonding agent is capable of chemically bonding with a bonding lug disposed in the channel and forming a lattice within the foot.

17. The method of claim 15 wherein the bonding agent forms an interference fit within the at least one bonding lug.

18. The method of claim 16 further comprising the step of leveling a top surface of the bonding lug, wherein the top surface is substantially co-planar with the hoof-facing surface.

19. The method of claim 15 wherein the at bonding lug is integrally formed within the body portion.
